(19) United States
(12) Patent Application Publication
(10) Pub. No.: US 2024/0176955 A1
(43) Pub. Date: May 30, 2024

(54) TEXT PROCESSING METHOD, MODEL TRAINING METHOD, DEVICE, AND STORAGE MEDIUM

(71) Applicant: Beijing Youzhuju Network Technology Co., Ltd., Beijing (CN)

(72) Inventors: Jiacheng ZHANG, Beijing (CN); Xueqing WU, Beijing (CN); Hang LI, Beijing (CN)

(21) Appl. No.: 18/283,597

(22) PCT Filed: Aug. 30, 2022
(86) PCT No.: PCT/CN2022/115826

§ 371 Date: Sep. 22, 2023

(30) Foreign Application Priority Data
Sep. 3, 2021 (CN) 202111033399.X

(51) Int. Cl. G06F 40/295

(52) U.S. Cl. CPC G06F 40/295

(57) ABSTRACT

Provided are a text processing method, a model training method, a device, and a storage medium. The text processing method includes: obtaining a source text; inputting the source text into a sequence-to-sequence model, to obtain a target sequence corresponding to the source text; and converting the target sequence into a target table.

### CROSS-REFERENCE TO RELATED APPLICATIONS

The present application claims a priority to Chinese Patent Application No. 202111033399.X, filed on Sep. 3, 2021, entitled “TEXT PROCESSING METHOD, MODEL TRAINING METHOD, DEVICE AND STORAGE MEDIUM”, the entire content of which is incorporated herein by reference.

### TECHNICAL FIELD

Embodiments of the present disclosure relate to the technical field of natural language processing (NLP), and more particularly, to a text processing method, a model training method, a device, and a storage medium.

### BACKGROUND

NLP refers to that the computer receives the user's input in natural language, and internally performs a series of operations, such as, processing and calculating, through the algorithm defined by humans, to simulate human's understanding on the natural language and return the user's expected results. For example, the computer may receive the source text and return a table formed by key information in the source text through a series of internal operations, such as processing, calculating, etc. by algorithms defined by humans.

At present, the computer can adopt the method of named entity extraction, and the specific process includes: a computer predefines an entity type, and after the computer obtains the source text, the source text is input into a pre-trained Bidirectional Encoder Representations from Transformers (BERT)-based model. The model can determine an entity type of each entity in the source text based on the predefined entity type, and then a corresponding relationship between the entity and the entity type is established, i.e. a table composed of the entity and the entity type is formed. The above named entity extraction method has the following defects: first, the format of the table formed by this way of named entity extraction is fixed and lacks flexibility, for example, the table must include two columns, one is for the entity and the other one is for the entity type. Second, the entity types need to be predefined, making the text processing process cumbersome, and resulting in inefficient text processing.

### SUMMARY

The present disclosure provides a text processing method, a model training method, a device, and a storage medium. Firstly, the target table obtained by the technical solution of the present disclosure is not limited to a two-column form, and the form of the target table is flexible. Secondly, there is no need to predefine the entity types in the technical solution provided by the present disclosure, so the text processing process is relatively simple, and thus the text processing efficiency can be improved.

In a first aspect, the present disclosure provides a text processing method. The text processing method includes: obtaining a source text; inputting the source text into a sequence-to-sequence model, to obtain a target sequence corresponding to the source text; and converting the target sequence into a target table.

In a second aspect, the present disclosure provides a model training method. The model training method includes: obtaining a plurality of first training samples and an initial model, the first training sample including: a text and a table corresponding to the text; converting the table into a sequence, the text and the sequence constituting a second training sample; and training the initial model with a plurality of second training samples corresponding to the plurality of first training samples to obtain a sequence-to-sequence model.

In a third aspect, the present disclosure provides a sequence-to-sequence model. The sequence-to-sequence model is an encoder and decoder framework, the decoder is of an N-layer structure, the decoder includes an output embedding layer, a self-attention network, a first processing network, and a second processing network. At S1, the source text is obtained and processed by the encoder to obtain a hidden state of the source text. At S2, for any to-be-outputted word in the target sequence, at least one outputted word in the target sequence is obtained and processed by the output embedding layer to obtain at least one word vector corresponding to the at least one outputted word. At S3, for each head in the single-head self-attention mechanism or multi-head self-attention mechanism, the at least one word vector is obtained by a first layer self-attention network, a header relationship vector between a first word vector and each second word vector is determined by the first layer self-attention network, and a third word vector is obtained by the first layer self-attention network based on the header relationship vector between the first word vector and each second word vector, and the at least one word vector, the first word vector being a last word vector in the at least one word vector, the second word vector being any word vector in the at least one word vector, and the third word vector corresponding to the first word vector. At S4, the third word vector is processed by a first layer first processing network based on the hidden state, to obtain a fourth word vector. At S5, S3 is performed by a second layer self-attention network taking the fourth word vector as a new first word vector and taking a word vector obtained by processing each second word vector by the first layer first processing network as each new second word vector, until an N^{th} layer first processing network outputs a fifth word vector corresponding to the first word vector. At S6, the fifth word vector is processed by the second processing network to obtain the to-be-outputted word.

In a fourth aspect, the present disclosure relates to a text processing apparatus. The text processing apparatus includes: an obtaining module, an input module, and a conversion module. The obtaining module is configured to obtain a source text. The input module is configured to input the source text into a sequence-to-sequence model to obtain a target sequence corresponding to the source text. The conversion module is configured to convert the target sequence into a target table.

In a fifth aspect, the present disclosure relates to a model training apparatus. The model training apparatus includes: an obtaining module, a conversion module, and a training module. The obtaining module is configured to obtain a plurality of first training samples and an initial model. The first training sample include: a text and a table corresponding to the text. The conversion module is configured to convert the table into a sequence. The text and the sequence constitute a second training sample. The training module is configured to train the initial model with a plurality of second training samples corresponding to the plurality of first training samples to obtain a sequence-to-sequence model.

In a sixth aspect, provided is an electronic device. The electronic device includes: a processor; and a memory having a computer program stored thereon. The processor is configured to invoke and execute the computer program stored in the memory to perform the method in the first aspect, the second aspect or implementations thereof.

In a seventh aspect, provided is a computer-readable storage medium having a computer program stored thereon. the computer program causes a computer to perform the method in the first aspect, the second aspect, or implementations thereof.

In an eighth aspect, provided is a computer program product including computer program instructions. The computer program instructions cause a computer to perform the method in the first aspect, the second aspect, or implementations thereof.

In a ninth aspect, provided is a computer program. The computer program causes a computer to perform the method in the first aspect, the second aspect, or implementations thereof.

With the technical solution provided by the present disclosure, firstly, the target table obtained by the technical solution of the present disclosure is not limited to a two-column form, and the form of the target table is flexible; and secondly, there is no need to predefine the entity types in the technical solution provided by the present disclosure, so that the text processing process is relatively simple, and thus the text processing efficiency can be improved.

### BRIEF DESCRIPTION OF DRAWINGS

In order to more clearly illustrate the technical solutions of the embodiments of the present disclosure, a brief description will be given below with reference to the accompanying drawings which are required to be used in the description of the embodiments. It is apparent that the drawings in the description below are only some embodiments of the present disclosure, and other drawings can be obtained by a person skilled in the art based on these drawings without involving any inventive effort.

FIG. 1 is a frame diagram of a Transformer;

FIG. 2 is a flowchart of a text processing method provided by an embodiment of the present disclosure;

FIG. 3 is a schematic diagram of a sequence-to-sequence model provided by an embodiment of the present disclosure;

FIG. 4 is a flowchart of a method for obtaining a target sequence provided by an embodiment of the present disclosure;

FIG. 5 is a flowchart of a model training method provided by an embodiment of the present disclosure;

FIG. 6 is a schematic diagram of a text processing apparatus 600 provided by an embodiment of the present disclosure;

FIG. 7 is a schematic diagram of a model training apparatus 700 provided by an embodiment of the present disclosure; and

FIG. 8 is a schematic block diagram of an electronic device 800 provided by an embodiment of the present disclosure.

### DESCRIPTION OF EMBODIMENTS

The embodiments of the present disclosure will now be described more fully hereinafter with reference to the accompanying drawings in the embodiments of the disclosure. It is to be understood that the embodiments described are only a few, but not all embodiments of the present disclosure. Based on the embodiments of the present disclosure, all other embodiments obtained by a person of ordinary skill in the art without inventive effort fall within the scope of the present invention.

It is noted that the terms “first”, “second”, and the like in the description and the claims, and the above-described figures, are used for distinguishing between similar objects and not necessarily for describing a particular sequential or chronological order. It is to be understood that the data used in this way are interchangeable under appropriate circumstances such that the embodiments of the present disclosure described herein are implemented in a sequence other than those illustrated or otherwise described herein. Furthermore, the terms “comprise”, “include” and “have”, as well as any variations thereof, are intended to cover a non-exclusive inclusion, such as, a process, method, system, product, or server that comprises a list of steps or elements is not necessarily limited to those steps or elements expressly listed, but may include other steps or elements not expressly listed or inherent to such process, method, product, or device.

Before introducing the technical solution of the present disclosure, the the relevant knowledge of the technical solution of the present disclosure is firstly elaborated below:

### I. Sequence to Sequence (Seq2Seq) Model:

In a broad sense, the purpose of using a sequence-to-sequence model is to convert a source sequence into a target sequence, which is not limited by the length of the two sequences, in other words, the length of the two sequences may be arbitrary. For example, the sequence may be a sentence, paragraph, chapter, text, etc.

It should be understood that the source sequence and the target sequence may be in the same language or in different languages. If the source sequence and the target sequence are in the same language, the meaning of the sequence-to-sequence model can be to extract the abstract or key information in the text. For example: the source sequence is a chapter and the target sequence is a paragraph, and then the meaning of the sequence-to-sequence model can be to extract the abstract or key information in the chapter. If the source sequence and the target sequence are not in the same language, the meaning of the sequence-to-sequence model can be language translation, etc. For example: the source sequence is an English text and the target sequence is a Chinese text, and then the meaning of the sequence to the sequence model may be to translate the English text to obtain the Chinese text.

The sequence-to-sequence model typically has an encoder and decoder framework:

The encoder processes a source sequence and compresses the source sequence into a context vector with a fixed length. The context vector is also referred to as a semantic code or a semantic vector. The context vector is expected to better represent the information of the source sequence.

The decoder is initialized with the context vector to obtain a target sequence.

### II. Transformer:

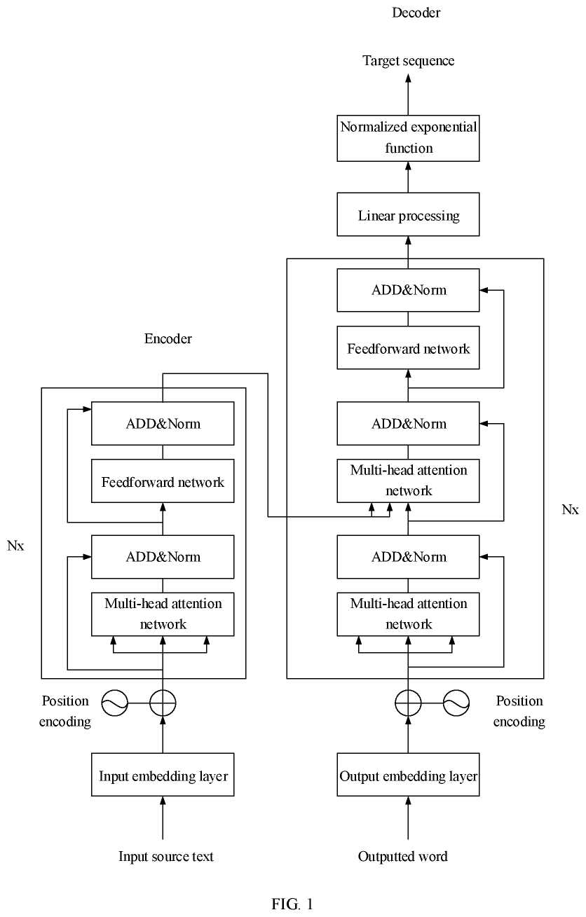

The sequence-to-sequence model can adopt Transformer. FIG. 1 is a frame diagram of the Transformer. As shown in FIG. 1, the encoder is composed of N=6 same units. Each unit contains two subunits. The first subunit is a self-attention network adopting a multi-head self-attention mechanism, the second subunit is a fully connected feedforward network, and the activation function is ReLU. Both subunits adopt residual connection (ADD) and layer normalization (Norm). The decoder is almost identical to the encoder, except that a layer of multi-head attention mechanism (encoder-decoder attention) is added in the middle to process the output of the encoder. Meanwhile, the first unit of the decoder, i.e., the first unit adopting the multi-headed self-attention mechanism, performs a masking operation in order to ensure that the decoder does not read the information after the current location.

### III. Attention Mechanism

The Attention model is generally viewed in natural language processing applications as an alignment model of a word in the target sequence and each word in the source sequence. The probability distribution of each word in the target sequence corresponding to each word in the source sequence can be understood as the alignment probability of each word in the source sequence and each word in the target sequence.

We can look at the attention mechanism: the constituent elements in the source sequence can be imagined as being composed of a series of (Key, Value) data pairs, where Key represents a key and Value represents a value. In this case, a certain element Query in the target sequence is given, the similarity or correlation between the Query and each Key is calculated, to obtain a weight coefficient of each Key corresponding to the Value, and then weighted summation is performed on the Value, to obtain a final Attention value. Here, all Query in the source sequence may form a Q matrix, all Key in the target sequence may form a K matrix, and all Value in the target sequence may form a V matrix. The attention mechanism is essentially to perform weighted summation on the Value of elements in a source sequence, and Query and Key are used to calculate a weight coefficient corresponding to the Value. Reference can be made to the following formula (1):

$$Attention ( {Query}_{i} , Source ) = {\sum }_{j = 1}^{N} Similarity ( {Query}_{i} , {Key}_{j} ) * {Value}_{j} , \qquad ( 1 )$$

where Queryᵢ represents the i^{th} query in the target sequence, Keyⱼ represents the j^{th} key in the source sequence, Valueⱼ represents the j^{th} value in the source sequence, Attention( ) represents the attention function, Similarity( ) represents the similarity function, and N is the number of outputted word vectors in the target sequence.

### IV. Self-Attention Mechanism

The self-Attention mechanism, also known as Intra-attention, is an attention mechanism that associates different positions of a single sequence in order to compute an interactive representation of the sequence. It is proven to be very efficient in many fields such as machine reading, text summarization or image description generation. In the self-attention mechanism, K=V=Q. Thus, in self-attention mechanism, an Attention value can be calculated by the following formula (2):

$$Attention ( Q , K , V ) = soft max ( \frac{{QK}^{T}}{\sqrt{n}} ) V , \qquad ( 2 )$$

where n represents the dimension of Query or Key, soft max ( ) represents a normalized exponential function, and other parameters can be referred to the above explanations, which will not be repeated in the present disclosure.

### V. Multi-Head Self-Attention Mechanism

Instead of computing attention only once, the multi-headed attention mechanism calculates attention on multiple subspaces in parallel multiple times, and finally simply concatenates and linearly transforms the attention on multiple subspaces to the desired dimension. Specifically, the multi-head attention value can be calculated by the following formula (3):

MultiHead(Q,K,V)=[headₗ; . . . ;headₕ]W^{O} where headᵢ=Attention(QWᵢ^{Q},K Wᵢ^{K},VWᵢ^{V}) (3),
where Wᵢ^{Q}, Wᵢ^{K}, Wᵢ^{V}, W^{O} are parameter matrices that need to learn with, each of which represents a transformation.

The technical problem to be solved by the present disclosure and the inventive concept are described as follows:

As described above, the current computer can adopt the method of named entity extraction, however, the method of named entity extraction has the following defects: first, the format of the table formed by this way of named entity extraction is fixed and lacks flexibility, for example: the table must include two columns, one is for the entity and the other one is for the entity type. Second, the entity types need to be predefined, making the text processing process cumbersome, resulting in inefficient text processing.

In order to solve the above-mentioned technical problem, the present disclosure provides a text processing method that can convert a source text into a target sequence through a sequence-to-sequence model and further can convert the target sequence into a target table.

The technical solution of the present disclosure will be described in detail as follows.

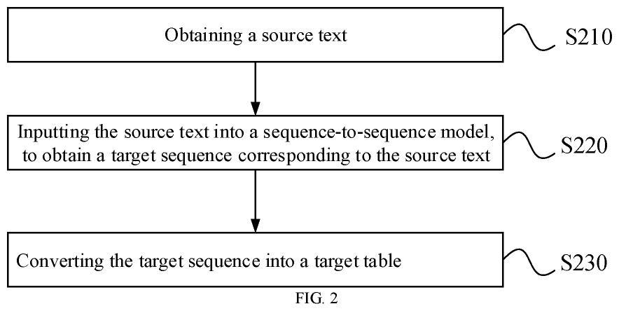

FIG. 2 is a flowchart of a text processing method provided by an embodiment of the present disclosure. The method can be performed by any electronic device such as a computer, a desktop computer, a notebook computer, etc., which is not limited in the present disclosure. As shown in FIG. 2, the method includes the following steps.

At S210, a source text is obtained.

At S220, the source text is inputted into a sequence-to-sequence model, to obtain a target sequence corresponding to the source text.

At S230, the target sequence is converted into a target table.

It should be understood that the source text herein is also understood as a source sequence.

It is to be understood that, as mentioned above, the input and output of the sequence-to-sequence model are both sequences, and in the present disclosure, the input source text and the output target sequence are both sequences in the same language, that is to say, in the present disclosure, the object achieved by the sequence-to-sequence model is to extract key information in the source text to obtain a target sequence corresponding to the form of the table. That is, the target sequence implicitly contains the format information of the table.

Illustratively, assuming that the source text is sports news as follows:

The Celtics saw great team play in their Christmas Day win, and it translated to the box score. Boston had 25 assists to just 11 for New York, and the team committed just six turnovers on the night. All-Star Isaiah Thomas once again led Boston with 27 points, while star center Al Horford scored 15 points and stuffed the stat sheet with seven rebounds, five assists, three steals, and two blocks. Third-year point guard Marcus Smart impressed off the bench, dishing seven assists and scoring 15 points including the game-winning three-pointer. New York, meanwhile, saw solid play from its stars. Sophomore big man Kristaps Porzingis had 22 points and 12 rebounds as well as four blocks. All-Star Carmelo Anthony had 29 points, 22 of which came in the second half. Point guard Derrick Rose also had 25 points in one of his highest-scoring outings of the season.

With the technical solution provided by the present disclosure, the above-mentioned source text can be converted into the following two target tables, one being a score table regarding teams, as shown in Table 1, and the other being a score table regarding players, as shown in Table 2:

TABLE 1

| | Number of team assists |
|---|---|
| Knicks | 11 |
| Celtics | 25 |

TABLE 2

| | Assists | Points | Total rebounds | Steals |
|---|---|---|---|---|
| Al Horford | 5 | 15 | 7 | 3 |
| Isaiah Thomas | | 27 | | |
| Marcus Smart | 7 | 15 | | |
| Carmelo Anthony | | 29 | | |
| Kristaps Porzingis | | 22 | 12 | |
| Derrick Rose | | 25 | | |

In summary, the present disclosure provides a text processing method that can convert a source text into a target sequence through a sequence-to-sequence model, and further, can convert the target sequence into a target table. Firstly, the target table obtained by the technical solution of the present disclosure is not limited to a two-column form, and the form of the target table is flexible. Secondly, there is no need to predefine entity types in the technical solution provided by the present disclosure, so that the text processing process is relatively simple, and thus the text processing efficiency can be improved.

It should be appreciated that the sequence-to-sequence model as described above is an encoder and decoder framework. The sequence-to-sequence model may be a Transformer framework, as shown in FIG. 1. The electronic device may adopt the self-attention mechanism described above. In this case, the electronic device obtains the target sequence through the sequence-to-sequence model is as follows: the source text is obtained and processed by the encoder to obtain a hidden state of the source text; for any to-be-outputted word in the target sequence, at least one outputted word in the target sequence is obtained and processed by the output embedding layer to obtain at least one word vector corresponding to the at least one outputted word; for each head in the single-head self-attention mechanism or the multi-head self-attention mechanism, at least one word vector is obtained by the self-attention network, and a word vector corresponding to the last word vector in the above-mentioned at least one word vector is obtained by the self-attention network based on the at least one word vector, namely, the obtained word vector is a word vector obtained by converting the last word vector; finally, the electronic device can process the hidden state and the obtained word vector to obtain to-be-outputted words, and these to-be-outputted words constitute a target sequence. This process can be adopted in the present disclosure to obtain a target sequence, and the process is of processing a source text by Transformer, and the detail thereof will be omitted for brevity. Of course, in the present disclosure, the sequence-to-sequence model has a certain specificity, namely, the target sequence obtained by the processing of the model corresponds to a form of the table, namely, the format or form of the target sequence is similar to the table. Therefore, in the present disclosure, when converting corresponding word vectors, the electronic device can consider the table header relationship between the word vectors, which is described in detail as follows.

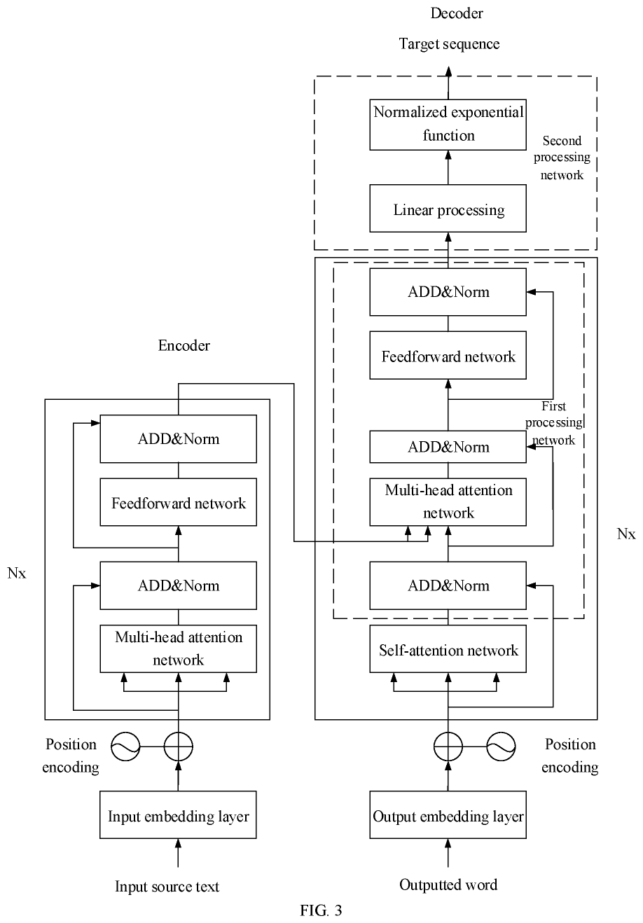

FIG. 3 is a schematic diagram of a sequence-to-sequence model provided by an embodiment of the present disclosure. As shown in FIG. 3, the sequence-to-sequence model is an encoder and decoder framework. The decoder is of an N-layer structure. The decoder includes an output embedding layer, an N-layer self-attention network, an N-layer first processing network, and a second processing network. The self-attention network adopts a single-head self-attention mechanism or a multi-head self-attention mechanism. If the self-attention network adopts a multi-head self-attention mechanism, the sequence-to-sequence model framework is a Transformer framework as shown in FIG. 1. The obtaining process of the target sequence is described below in conjunction with the sequence-to-sequence model shown in FIG. 3.

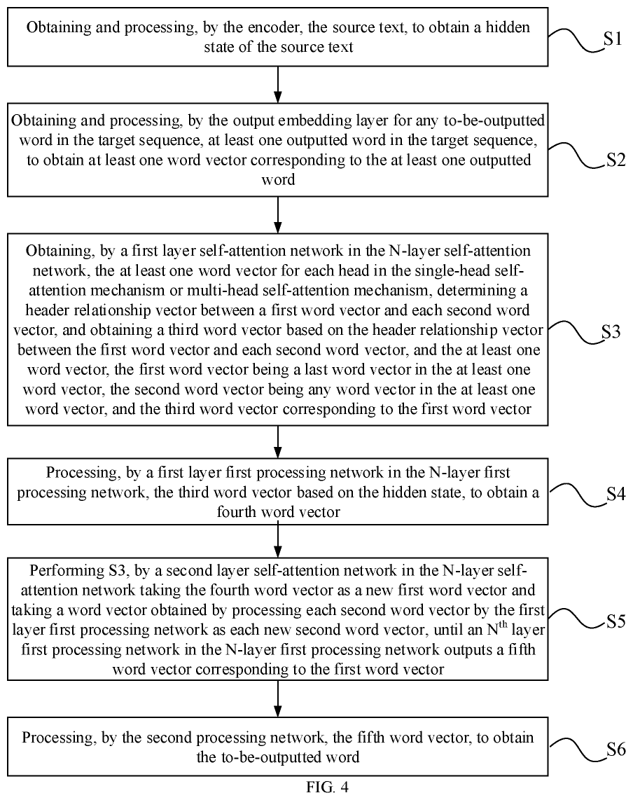

FIG. 4 is a flowchart of a method for obtaining a target sequence provided by an embodiment of the present disclosure. The method can be performed by any electronic device such as a computer, a desktop computer, a notebook computer, etc., which is not limited in the present disclosure. As shown in FIG. 4, the method includes the following steps.

At S1, the source text is obtained and processed by the encoder to obtain a hidden state of the source text.

At S2, for any to-be-outputted word in the target sequence, at least one outputted word in the target sequence is obtained and processed by the output embedding layer to obtain at least one word vector corresponding to the at least one outputted word.

At S3, for each head in the single-head self-attention mechanism or multi-head self-attention mechanism, the at least one word vector is obtained by a first layer self-attention network, a header relationship vector between a first word vector and each second word vector is determined by the first layer self-attention network, and a third word vector is obtained by the first layer self-attention network based on the header relationship vector between the first word vector and each second word vector, and the at least one word vector. The first word vector is a last word vector in the at least one word vector, the second word vector is any word vector in the at least one word vector, and the third word vector corresponds to the first word vector.

At S4, the third word vector is processed by a first layer first processing network based on the hidden state, to obtain a fourth word vector.

At S5, S3 is performed by a second layer self-attention network taking the fourth word vector as a new first word vector and taking a word vector obtained by processing each second word vector by the first layer first processing network as each new second word vector, until an N^{th} layer first processing network outputs a fifth word vector corresponding to the first word vector.

At S6, the fifth word vector is processed by the second processing network to obtain the to-be-outputted word.

It should be understood that the process of processing the source text by the encoder may refer to the process of processing the source text by the encoder in Transformer, the process of processing at least one outputted word by the output embedding layer may refer to the process of processing the source text by the output embedding layer in Transformer, and the processing process of the first processing network and the second processing network may refer to the processing process of Transformer, and the detail thereof will be omitted for brevity.

The details of S3 will be highlighted as follows.

In some implementations, the first layer self-attention network described above may determine the header relationship vector between the first word vector and the second word vector by way of, but not limited to: determining, by the self-attention network, whether the first word vector and the second word vector have a header relationship; when the first word vector and the second word vector have no header relationship, determining, by the self-attention network, the header relationship vector between the first word vector and the second word vector as a zero vector; when the first word vector and the second word vector have a row header relationship, determining, by the self-attention network, the header relationship vector between the first word vector and the second word vector as a first vector; and when the first word vector and the second word vector have a column header relationship, determining, by the self-attention network, the header relationship vector between the first word vector and the second word vector as a second vector.

It should be appreciated that the header relationship between the first word vector and the second word vector is the header relationship between the outputted word corresponding to the first word vector and the outputted word corresponding to the second word vector in the target sequence.

It should be understood that the outputted word corresponding to the first word vector and the outputted word corresponding to the second word vector may have no header relationship, or may have a row header relationship, or may have a column header relationship.

In some implementations, the target sequence output by the sequence-to-sequence model has the following characteristics: the target sequence corresponds to the form of a table, i.e., each cell in the table appears in the target sequence as a character preceding and succeeding the word filled in the cell, which is a delimiter “|”, and the line break in the table appears in the target sequence as indicated by the enter “\n”. Based on this, the electronic device can determine the format of the outputted words in the target sequence based on the delimiter “|” and “\n”.

By way of example, assuming that the source text is the sports news as described above, the electronic device may generate a target sequence regarding the teams. In the process of generating the target sequence, it is assumed that a part of the target sequence has been generated, i.e., including some outputted words as follows:

| | Number of team assists | Steals | \n
| Knicks | 11 | ... ...

As can be seen from a part of the format of the target sequence, 11 is in a column header relationship with the Number of team assists, i.e., Number of team assists is a column header of 11, and 11 is in a row header relationship with Knicks, i.e., Knicks is a row header of 11.

It should be understood that the first vector described above is used to characterize a row table header relationship and the second vector is used to characterize a column header relationship. The parameters included by the first vector and the second vector may be obtained during the training of the sequence-to-sequence model.

It should be understood that the third word vector is a transformation of the first word vector. And when the sub-attention network adopts a multi-head self-attention mechanism, the electronic device calculates a third word vector for each head. When the sub-attention network described above adopts a single head self-attention mechanism, the electronic device calculates only a single third word vector.

In some implementations, the first layer self-attention network may obtain the third word vector by way of, but not limited to: performing, by the first layer self-attention network, a first transformation on the first word vector, to obtain a query corresponding to the first word vector; performing, by the first layer self-attention network, a second transformation on the each second word vector, to obtain a key corresponding to each second word vector; determining, by the first layer self-attention network, a similarity between the first word vector and each second word vector based on the query corresponding to the first word vector, the key corresponding to each second word vector, and a first header relationship vector between the first word vector and each second word vector, the header relationship vector between the first word vector and each second word vector including: the first header relationship vector being a header relationship vector corresponding to the key corresponding to each second word vector; performing, by the first layer self-attention network, a third transformation on each second word vector, to obtain a value corresponding to each second word vector; and determining, by the first layer self-attention network, the third word vector based on the similarity between the first word vector and each second word vector, the value corresponding to each second word vector, and a second header relationship vector between the first word vector and each second word vector, the header relationship vector between the first word vector and each second word vector including: the second header relationship vector being a header relationship vector corresponding to the value corresponding to each second word vector.

It should be understood that the first transformation here is implemented by a transformation matrix. The transformation matrix is used for mapping the first word vector to its corresponding Query, e.g., the first word vector is xᵢ, and the transformation matrix is W^{Q}, then the first transformation is xᵢW^{Q}. Similarly, the second transformation here is also implemented by a transformation matrix. The transformation matrix is used for mapping the second word vector to its corresponding Key, e.g., the second word vector is xⱼ, and the transformation matrix is W^{K}, then the second transformation is xⱼW^{K}. Based on this, assuming that the header relationship vector between the first word vector xᵢ and the second word vector xⱼ is rᵢⱼ, then the first header relationship vector may be rᵢⱼ^{K}=rᵢⱼW^{K} and the second header relationship vector may be rᵢⱼ^{V}=rᵢⱼW^{V}.

In some implementations, for each second word vector, the first layer self-attention network may calculate a sum of the key corresponding to the second word vector and the first header relationship vector between the first word vector the second word vector, to obtain a first result, and may calculate the similarity between the first result and the first word vector by using any similarity function, which is not limited in the present disclosure.

Illustratively, the first layer self-attention network calculates a product of a query corresponding to the first word vector and the first result to obtain a second result; the first layer self-attention network calculates the quotient of the second result and the dimension of the query corresponding to the first word vector to obtain a third result; and the first layer self-attention network performs normalization processing on each third result to obtain the similarity between the first word vector and each second word vector. Reference can be made to the following formulas (4) and (5) for details:

$${e}_{ij} = \frac{( {x}_{i} {W}^{Q} ) ( {x}_{j} {W}^{K} + {r}_{ij}^{K} )}{\sqrt{{d}_{z}}} , and \qquad ( 4 )$$

$${α}_{ij} = \frac{exp {e}_{ij}}{{\sum }_{j = 1}^{i} {e}_{ij}} , \qquad ( 5 )$$

where xᵢ represents a first word vector, W^{Q} represents a transformation matrix corresponding to the first transformation, xᵢW^{Q} represents a first transformation that is performed on the first word vector, xⱼ represents a second word vector, W^{K} represents a transformation matrix corresponding to the second transformation, xⱼW^{K} represents a second transformation that is performed on the second word vector, rᵢⱼ^{K} represents a first header relationship vector between xᵢ and xⱼ, d_{z} represents a dimension of the first word vector, which is also a dimension of the second word vector, and a dimension of the finally obtained third word vector, eᵢⱼ represents a third result, and αᵢⱼ represents the similarity between xᵢ and xⱼ.

It should be understood that the similarity between the first word vector and the second word vector can also be obtained by any modification of the above-mentioned formula (4) and formula (5) in the present disclosure, which is not limited in the present disclosure.

In some implementations, for any second word vector, the first layer self-attention network can calculate the sum of a value corresponding to each second word vector and a second header relationship vector between the first word vector and each second word vector to obtain a fourth result; based on the fourth result and the corresponding similarity, the above-mentioned third word vector is obtained.

Illustratively, the first layer self-attention network multiplies each fourth result with a corresponding similarity to obtain a fifth result; the self-attention network calculates a sum of all the fifth results to obtain the third word vector. Reference can be made to the following formula (6) for details:

$${z}_{i} = {\sum }_{j = 1}^{i} {α}_{ij} ( {x}_{j} {W}^{V} + {r}_{ij}^{V} ) , \qquad ( 6 )$$

where zᵢ represents a third vector, xⱼ represents a second word vector, W^{V} represents a transformation matrix corresponding to a third transformation, xⱼW^{V} represents a third transformation that is performed on the second word vector, rᵢⱼ^{V} represents a second header relationship vector between xᵢ and xⱼ, xⱼW^{V}+rᵢⱼ^{V} represents a fourth result αᵢⱼ, represents the similarity of xᵢ and xⱼ, and αᵢⱼ(xⱼW^{V}+rᵢⱼ^{V}) represents a fifth result.

It should be understood that the third word vector can also be obtained by any modification of the above formula (6) in the present disclosure, which is not limited in the present disclosure.

It should be understood that if the self-attention network adopts a multi-headed self-attention mechanism, then each head corresponds to its transformation matrix W^{Q}, W^{K}, W^{V}. For W^{Q}, the W^{Q} corresponding to different heads may be the same or different; for W^{K}, the W^{K} corresponding to different heads may be the same or different; for W^{V}, the W^{V} corresponding to different heads may be the same or different, and the present disclosure is not limited thereto.

It should be appreciated that if the self-attention network adopts a multi-headed self-attention mechanism, the electronic device may obtain a fifth word vector for each of the plurality of heads. Based on this, the electronic device may obtain a final attention value based on formula (3), but the present disclosure is not limited thereto.

In order to make the format of the obtained target sequence correspond to a format of the table, in the present disclosure, the process of decoding the source text by the decoder satisfies the following decoding constraint conditions: when generating a first row of the target sequence, only a line break or an end mark is generated after a delimiter; and when generating remaining rows of the target sequence other than the first row, the number of columns of the remaining rows is same as the number of columns of the first row, and only a line break or an end mark is generated after a delimiter.

In other words, when generating a first row of the target sequence, only a line break or an end mark is generated after a delimiter; and when generating the remaining rows of the target sequence other than the first row, only a line break or end mark is generated when the number of delimiters generated coincides with the first row.

In summary, in the present disclosure, the electronic device may consider a header relationship between word vectors when converting the corresponding word vector, so that the obtained target sequence is more accurate.

The decoding constraint condition is set in the present disclosure, so that the format of the target sequence can correspond to the format of the table so that the obtained target sequence is more accurate.

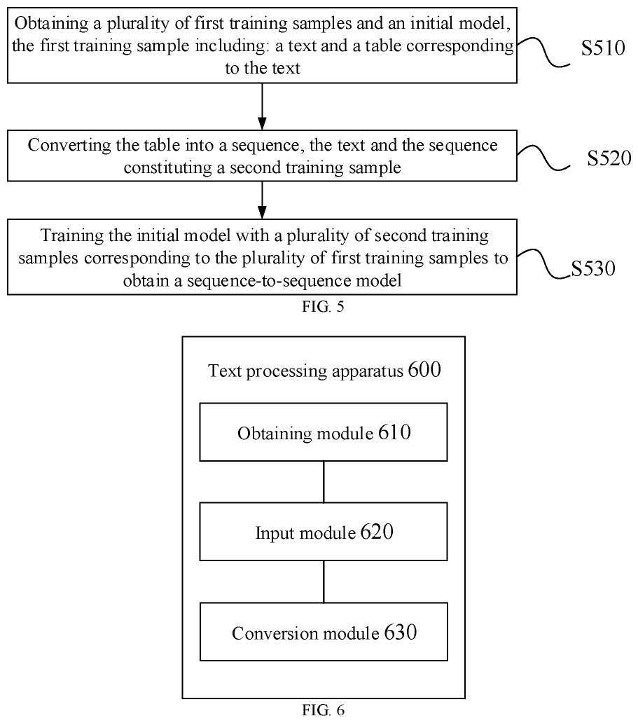

FIG. 5 is a flowchart of a model training method provided an embodiment of the present disclosure. The method can be performed by any electronic device such as a computer, a desktop computer, a notebook computer, etc., and the present disclosure is not limited thereto. It should be noted that the device for performing the model training method and the device for performing the above-mentioned text processing method can be the same device or different devices, and the present disclosure is not limited thereto. As shown in FIG. 5, the method includes the following steps.

At S510, a plurality of first training samples and an initial model are obtained, the first training sample including: a text and a table corresponding to the text.

At S520, the table is converted into a sequence, the text and the sequence constituting a second training sample.

At S530, the initial model is trained with a plurality of second training samples corresponding to the plurality of first training samples to obtain a sequence-to-sequence model.

In some implementations, the electronic device may pre-process the text and sequence described above, such as: byte pair encoding, etc., and the present disclosure is not limited thereto.

In some implementations, the electronic device may separate different cells of the same row in the table with a delimiter and separate different rows in the table with a line break, to obtain a sequence. Of course, the electronic device may separate different cells of the same row in the table with other symbols, such as comma, and the present disclosure is not limited thereto. The electronic device may separate different rows in the table with other symbols, such as period, and the present disclosure is not limited thereto.

Illustratively, the sequence corresponding to Table 2 may be in the form below:

| | Assists | Points | Total rebounds | Steals |\n
| Al Horford | 5 | 15 | 7 | 3 |\n
... ...
| Derrick Rose | | 25 | | |

In some implementations, the initial model may be, but is not limited to, a Transformer model.

It should be noted that the present disclosure can train the initial model by adopting any existing model training method, and the present disclosure is not limited thereto.

In summary, in the present disclosure, the electronic device can obtain a plurality of first training samples and an initial model, the first training sample including: a text and a table corresponding to the text; convert the table into a sequence, the text and the sequence constituting a second training sample; and train the initial model with a plurality of the second training samples corresponding to the plurality of first training samples, to obtain a sequence-to-sequence model, so that the format of the sequence output by the sequence-to-sequence model is similar to a format of the table. In the implementation process, a target sequence similar to the format of the table can be generated, and a target table can be accurately generated.

It should be understood that the current method of processing text may be in the form of named entity extraction as described above, or may be a relationship extraction method, or may be a text classification method. Relationship extraction refers to extracting entities from the text, pairing the entities pair by pair, and predicting whether there is a relationship between the two and what type of relationship exists. The general solution is to perform the named entity extraction first, then pair the extracted entities pair by pair, and use pre-trained BERT to predict the relationship between two entities. Text classification is to define a plurality of attribute categories based on a specific application scenario, and to predict a specific tag for each category, and the general solution thereof is to use BERT.

For four existing data sets of Rotowire, E2E, WikiTableText, and WikiBio, the technical solution of the present disclosure and the above-mentioned technical solution in the prior art are adopted to compare the performing results.

Rotowire: the score of the team and the score of the player is generated from the sports report and the output includes two tables, one table is for the team and the other table is for the player.

E2E: the table describing the restaurant is generated from the restaurant reviews and the output is a table with two columns, one column is of attribute name and the other column is of attribute value.

WikiTableText: the data set is an open domain data set and the table is generated from the text description. The table is extracted from Wikipedia, and similar to E2E, the table is with two columns, one column is of attribute name and the other column is of attribute value.

WikiBio: the table is generated from the celebrity's text description, where both the text and the table are extracted from Wikipedia. Similar to E2E, as the table is with two columns, one column is of attribute name, and the other column is of attribute value.

Since the existing methods are not universally applicable to all the data sets, relationship extraction method is used for Rotowire, the named entity extraction method is used for E2E, WikiTableText, and WikiBio, and text classification method is used for E2E. The Rotowire results are shown in Table 3.

TABLE 3

| | Team | Team table | Player | Team table |
|---|---|---|---|---|
| | table | format error | table | format error |
| Method | f1 | rate | f1 | rate |
| Sentence-level | 77.17 | — | 79.59 | — |
| relationship extraction | | | | |
| Document-level | 75.66 | — | 80.76 | — |
| relationship extraction | | | | |
| Sequence-to-sequence | 82.97 | 0.49% | 81.96 | 7.40% |
| model | | | | |
| Improved sequence-to- | 82.53 | 0.00% | 82.53 | 0.00% |
| sequence model (namely, | | | | |
| the technical solution | | | | |
| of the present disclosure) | | | | |

E2E results are shown in Table 4.

TABLE 4

| | | Table format |
|---|---|---|
| Method | Table f1 | error rate |
| Named entity extraction | 90.80 | — |
| Text classification | 90.25 | — |
| Sequence-to-sequence model | 97.84 | 0.00% |
| Improved sequence-to-sequence model | 97.88 | 0.00% |

WikiTableText result and the WikiBio result are shown in Table 5.

TABLE 5

| | | | | WikiBio |
|---|---|---|---|---|
| | | WikiTableText | | table |
| | WikiTableText | table format | WikiBio | format |
| Method | table f1 | error rate | table f1 | error rate |
| Named entity | 52.23 | — | 56.51 | — |
| extraction | | | | |
| Sequence-to- | 59.26 | 0.41% | 68.98 | 0.00% |
| sequence | | | | |
| model | | | | |
| Improved | 59.14 | 0.00% | 69.02 | 0.00% |
| sequence-to- | | | | |
| sequence | | | | |
| model | | | | |

The sequence-to-sequence model outperforms the existing methods for all the data sets. The improved sequence-to-sequence of the present disclosure eliminates the wrong format and significantly improves the table index f1 for the Rotowire data set, but the effect is not so obvious for other data sets because the tables of other data sets are simple.

Embodiments of the present disclosure also provide a sequence-to-sequence model, as shown in FIG. 3. The sequence-to-sequence is an encoder and decoder framework, the decoder being of an N-layer structure, the decoder including an output embedding layer, an N-layer self-attention network, an N-layer first processing network, and a second processing network.

At S1, the source text is obtained and processed by the encoder to obtain a hidden state of the source text.

At S2, for any to-be-outputted word in the target sequence, at least one outputted word in the target sequence is obtained and processed by the output embedding layer to obtain at least one word vector corresponding to the at least one outputted word.

At S3, for each head in the single-head self-attention mechanism or multi-head self-attention mechanism, the at least one word vector is obtained by a first layer self-attention network, a header relationship vector between a first word vector and each second word vector is determined by the first layer self-attention network, and a third word vector is obtained by the first layer self-attention network based on the header relationship vector between the first word vector and each second word vector, and the at least one word vector. The first word vector is a last word vector in the at least one word vector, the second word vector is any word vector in the at least one word vector, and the third word vector corresponds to the first word vector.

At S4, the third word vector is processed by a first layer first processing network based on the hidden state, to obtain a fourth word vector.

At S5, S3 is performed by a second layer self-attention network taking the fourth word vector as a new first word vector and taking a word vector obtained by processing each second word vector by the first layer first processing network as each new second word vector, until an N^{th} layer first processing network outputs a fifth word vector corresponding to the first word vector.

At S6, the fifth word vector is processed by the second processing network to obtain the to-be-outputted word.

In some implementations, the first layer self-attention network is specifically configured to: determine whether the first word vector and the second word vector have a header relationship. When the first word vector and the second word vector have no header relationship, the first layer self-attention network is configured to determine the header relationship vector between the first word vector and the second word vector as a zero vector. When the first word vector and the second word vector have a row header relationship, the first layer self-attention network is configured to determine the header relationship vector between the first word vector and the second word vector as a first vector. When the first word vector and the second word vector have a column header relationship, the first layer self-attention network is configured to determine the column header relationship vector between the first word vector and the second word vector as a second vector.

In some implementations, the first layer self-attention network is specifically configured to: perform a first transformation on the first word vector, to obtain a query corresponding to the first word vector; perform a second transformation on the each second word vector, to obtain a key corresponding to each second word vector; determine a similarity between the first word vector and each second word vector based on the query corresponding to the first word vector, the key corresponding to each second word vector, and a first header relationship vector between the first word vector and each second word vector, the header relationship vector between the first word vector and each second word vector including: the first header relationship vector being a header relationship vector corresponding to the key corresponding to each second word vector; perform a third transformation on each second word vector, to obtain a value corresponding to each second word vector; and determine the third word vector based on the similarity between the first word vector and each second word vector, the value corresponding to each second word vector, and a second header relationship vector between the first word vector and each second word vector, the header relationship vector between the first word vector and each second word vector including: the second header relationship vector being a header relationship vector corresponding to the value corresponding to each second word vector.

In some implementations, the first layer self-attention network is specifically configured to: calculate a sum of the key corresponding to each second word vector and the first header relationship vector between the first word vector and each second word vector, to obtain a first result; calculate a product of the query corresponding to the first word vector and the first result, to obtain a second result; calculate a quotient of the second result and a dimension of the query corresponding to the first word vector, to obtain a third result; and perform normalization processing on each third result, to obtain the similarity between the first word vector and each second word vector.

In some implementations, the first layer self-attention network is specifically configured to: calculate the sum of a value corresponding to the each second word vector and a second header relationship vector between the first word vector and each second word vector to obtain a fourth result, multiply each fourth result with a corresponding similarity to obtain a fifth result, and calculate a sum of all the fifth results to obtain the third word vector.

It is to be understood that the sequence-to-sequence model can be used to implement the above-described text processing method, and the contents and effects thereof can be referred to the above-described text processing method, and detail of the contents and effects thereof will be omitted for brevity in the present disclosure.

FIG. 6 is a schematic diagram of a text processing apparatus 600 provided by an embodiment of the present disclosure. As shown in FIG. 6, the apparatus 600 includes an obtaining module 610, an input module 620, and a conversion module 630. The obtaining module 610 is configured to obtain a source text. The input module 620 is configured to input the source text into a sequence-to-sequence model to obtain a target sequence corresponding to the source text. The conversion module 630 is configured to convert the target sequence into a target table.

In some implementations, the sequence-to-sequence model is an encoder and decoder framework, the decoder is of an N-layer structure, the decoder includes an output embedding layer, a self-attention network, a first processing network, and a second processing network. The self-attention network adopts a single-head self-attention mechanism or a multi-head self-attention mechanism. The input module 620 is specifically configured to: at S1, obtain and process, by the encoder, the source text, to obtain a hidden state of the source text; at S2, obtain and process, by the output embedding layer for any to-be-outputted word in the target sequence, at least one outputted word in the target sequence, to obtain at least one word vector corresponding to the at least one outputted word; at S3, obtain, by a first layer self-attention network, the at least one word vector for each head in the single-head self-attention mechanism or multi-head self-attention mechanism, determine a header relationship vector between a first word vector and each second word vector, and obtain a third word vector based on the header relationship vector between the first word vector and each second word vector, and the at least one word vector, the first word vector being a last word vector in the at least one word vector, the second word vector being any word vector in the at least one word vector, and the third word vector corresponding to the first word vector; at S4, process, by a first layer first processing network, the third word vector based on the hidden state, to obtain a fourth word vector; at S5, perform S3, by a second layer self-attention network taking the fourth word vector as a new first word vector and taking a word vector obtained by processing each second word vector by the first layer first processing network as each new second word vector, until an N^{th} layer first processing network outputs a fifth word vector corresponding to the first word vector; and at S6, process, by the second processing network, the fifth word vector, to obtain the to-be-outputted word.

In some implementations, the input module 620 is specifically configured to: determine, by the first layer self-attention network, whether the first word vector and the second word vector have a header relationship; when the first word vector and the second word vector have no header relationship, determine, by the self-attention network, the header relationship vector between the first word vector and the second word vector as a zero vector; when the first word vector and the second word vector have a row header relationship, determine, by the self-attention network, the header relationship vector between the first word vector and the second word vector as a first vector; and when the first word vector and the second word vector have a column header relationship, determine, by the self-attention network, the header relationship vector between the first word vector and the second word vector as a second vector.

In some implementations, the input module 620 is specifically configured to: perform, by the first layer self-attention network, a first transformation on the first word vector, to obtain a query corresponding to the first word vector; perform, by the first layer self-attention network, a second transformation on each second word vector, to obtain a key corresponding to each second word vector; determine, by the first layer self-attention network, a similarity between the first word vector and each second word vector based on the query corresponding to the first word vector, the key corresponding to each second word vector, and a first header relationship vector between the first word vector and each second word vector, the header relationship vector between the first word vector and each second word vector including: the first header relationship vector being a header relationship vector corresponding to the key corresponding to each second word vector; perform, by the first layer self-attention network, a third transformation on each second word vector, to obtain a value corresponding to each second word vector; and determine, by the first layer self-attention network, the third word vector based on the similarity between the first word vector and each second word vector, the value corresponding to each second word vector, and a second header relationship vector between the first word vector and each second word vector, the header relationship vector between the first word vector and each second word vector including: the second header relationship vector being a header relationship vector corresponding to the value corresponding to each second word vector.

In some implementations, the input module 620 is specifically configured to: calculate, by the first layer self-attention network, a sum of the key corresponding to each second word vector and the first header relationship vector between the first word vector and each second word vector, to obtain a first result; calculate, by the first layer self-attention network, a product of the query corresponding to the first word vector and the first result, to obtain a second result; calculate, by the first layer self-attention network, a quotient of the second result and a dimension of the query corresponding to the first word vector, to obtain a third result; and perform, by the first layer self-attention network, normalization processing on each third result, to obtain the similarity between the first word vector and each second word vector.

In some implementations, the input module 620 is specifically configured to: calculate, by the first layer self-attention network, a sum of the value corresponding to each second word vector and the second header relationship vector between the first word vector and each second word vector, to obtain a fourth result; multiply, by the first layer self-attention network, each fourth result with a corresponding similarity, to obtain a fifth result; and calculate, by the first layer self-attention network, a sum of all the fifth results, to obtain the third word vector.

In some implementations, the process of decoding the source text by the decoder satisfies the following decoding constraint conditions: when generating a first row of the target sequence, only a line break or an end mark is generated after a delimiter; and when generating remaining rows of the target sequence other than the first row, the number of columns of the remaining rows is same as the number of columns of the first row, and only a line break or an end mark is generated after a delimiter.

It should be understood that the apparatus embodiments and the method embodiments may correspond to each other and that similar description of the apparatus embodiments may refer to the method embodiments, and the detail thereof will be omitted for brevity. In particular, the apparatus 600 shown in FIG. 6 may perform the method embodiment corresponding to FIG. 2, and the foregoing and other operations and/or functions of the various modules in apparatus 600 are used for implementing the corresponding flows in the various methods of FIG. 2, and the detail thereof will be omitted for brevity.

Apparatus 600 in an embodiment of the present disclosure is described above from the point of view of functional blocks with reference to the accompanying drawings. It is to be understood that the functional blocks may be implemented in the form of hardware, in the form of instructions in software, or the form of a combination of hardware and software modules. In particular, the steps of an method embodiment in the present disclosure may be performed by instructions in the form of integrated logic circuits in hardware and/or software in a processor, and the steps of a method disclosed in conjunction with the embodiments of the present disclosure may be performed directly by a hardware decoding processor or by a combination of hardware and software modules in a decoding processor. Alternatively, the software module may reside in the mature storage medium in the art, such as, random access memory, flash memory, read-only memory, programmable read-only memory, electrically erasable programmable memory, registers. The storage medium is located in a memory, and the processor reads the information in the memory, and in conjunction with its hardware, performs the steps in the above-mentioned method embodiments.

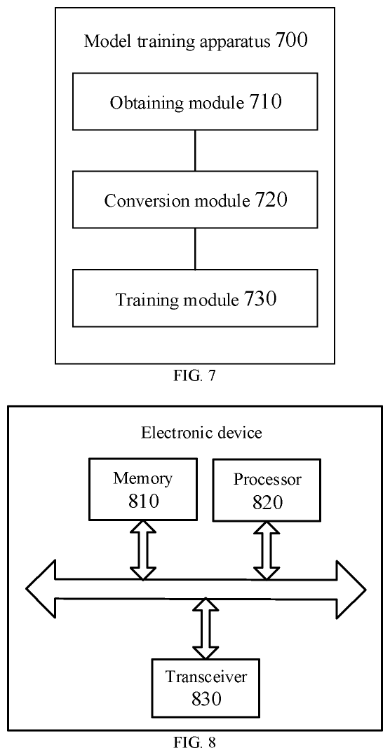

FIG. 7 is a schematic diagram of a model training apparatus 700 provided by an embodiment of the present disclosure, as shown in FIG. 7. The apparatus 700 includes an obtaining module 710, a conversion module 720, and a training module 730. The obtaining module 710 is configured to obtain a plurality of first training samples and an initial model, the first training sample including: a text and a table corresponding to the text. The conversion module 720 is configured to convert the table into a sequence, the text and the sequence constituting a second training sample. The training module 730 is configured to train the initial model with a plurality of the second training samples corresponding to the plurality of first training samples to obtain a sequence-to-sequence model.

In some implementations, the conversion module 720 is specifically configured to: separate different cells of the same row in the table with delimiters and separate different rows in the table with line breaks to obtain the sequence.

It should be understood that the apparatus embodiments and the method embodiments may correspond to each other and that similar descriptions of the apparatus embodiments may refer to method embodiments, and detail thereof will be omitted for brevity. In particular, the apparatus 700 shown in FIG. 7 may perform the method embodiment corresponding to FIG. 5, and the foregoing and other operations and/or functions of the various modules in apparatus 700 are used for implementing the corresponding flows in the various methods of FIG. 5, and detail thereof will be omitted for brevity.

Apparatus 700 in an embodiment of the present disclosure is described above from the point of view of functional blocks with reference to the accompanying drawings. It is to be understood that the functional blocks may be implemented in the form of hardware, in the form of instructions in software, or the form of a combination of hardware and software modules. In particular, the steps of an method embodiment of the present disclosure may be performed by instructions in the form of integrated logic circuits in hardware and/or software in a processor, and the steps of a method disclosed in conjunction with the embodiments of the present disclosure may be performed directly by a hardware decoding processor or by a combination of hardware and software modules in a decoding processor. Alternatively, the software module may reside in the mature storage medium in the art, such as, random access memory, flash memory, read-only memory, programmable read-only memory, electrically erasable programmable memory, registers. The storage medium is located in a memory, and the processor reads the information in the memory, and in conjunction with its hardware, performs the steps in the above-mentioned method embodiments.

FIG. 8 is a schematic block diagram of an electronic device 800 provided by an embodiment of the present disclosure.

As shown in FIG. 8, the electronic device 800 may include: a memory 810 and a processor 820. The memory 810 has a computer program stored thereon and is configured to transmit the program codes to the processor 820. In other words, the processor 820 can invoke and execute the computer program from memory 810 to implement the method of the embodiments of the present disclosure.

For example, the processor 820 may be configured to perform the method embodiments described above based on instructions in the computer program.

In some embodiments of the present disclosure, the processor 820 may include, but is not limited to:
a general-purpose processor, a digital signal processor (DSP), an application-specific integrated circuit (ASIC), a field programmable gate array (FPGA) or other programmable logic devices, a discrete gate or transistor logic device, a discrete hardware component, etc.

In some embodiments of the present disclosure, the memory 810 includes, but is not limited to:
volatile memory and/or non-volatile memory. The non-volatile memory may be a read-only memory (ROM), a programmable read-only memory (Programmable ROM, PROM), an erasable PROM (EPROM), an electrically EPROM (EEPROM) or a flash memory. The volatile memory can be random access memory (RAM), which acts as an external cache. By way of illustration and not limitation, many forms of RAM are available, such as static RAM (SRAM), dynamic RAM (DRAM), synchronous DRAM (SDRAM), double data rate SDRAM (DDR SDRAM), enhanced SDRAM (ESDRAM), synch link DRAM (SLDRAM), and direct memory bus random access memory (Direct Rambus RAM, DR RAM).

In some embodiments of the present disclosure, the computer program may be partitioned into one or more modules that are stored in memory 810 and executed by processor 820 to perform the methods provided herein. One or more modules may be a series of computer program instruction segments capable of performing specific functions, and the instruction segment describes the execution process of the computer program in the traffic control device.

As shown in FIG. 8, the traffic flow control device may further include:
a transceiver 830 connected to the processor 820 or the memory 810.

The processor 820 can control the transceiver 830 to communicate with other devices, and in particular, can transmit information or data to or receive information or data transmitted by other devices. The transceiver 830 may include a transmitter and a receiver. The transceiver 830 may further include one or more antennas.

It will be appreciated that the various components of the traffic control device are connected by a bus system which includes a power bus, a control bus, and a status signal bus in addition to a data bus.

The present disclosure also provides a computer storage medium having stored thereon a computer program. The computer program, when executed by a computer, causes the computer to perform the method of the above-described method embodiments. Alternatively, the embodiments of the present disclosure provide a computer program product including instructions that, when executed by a computer, cause the computer to perform the method of the above-described method embodiments.

When implemented in software, it may be implemented in whole or in part as a computer program product. The computer program product includes one or more computer instructions. The computer program instructions, when loaded and executed on a computer, the process or function in accordance with the embodiments of the present disclosure is generated in whole or in part. The computer may be a general-purpose computer, a special-purpose computer, a computer network, or other programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center by wire (e.g., coaxial cable, fiber optic, digital subscriber line (DSL)) or wirelessly (e.g., infrared, wireless, microwave, etc.). The computer-readable storage medium can be any available medium that can be accessed by a computer or a data storage device, such as, a server, data center which includes one or more available media integrated thereon. The available medium may be a magnetic medium (e.g., floppy disk, hard disk, magnetic tape), an optical medium (e.g., digital video disc (DVD)), or a semiconductor medium (e.g., solid state disk (SSD)), etc.

Those of ordinary skill in the art would realize that the various illustrative modules and algorithm steps described in conjunction with the embodiments disclosed herein may be implemented as electronic hardware or combinations of computer software and electronic hardware. Whether such functionality is implemented as hardware or software depends upon the particular application and design constraints imposed on the implementation. The skilled person may implement the described functionality in different ways for each particular application, but such implementation should not be interpreted as being out of the scope of the present disclosure.

In the several embodiments provided herein, it should be understood that the disclosed systems, apparatuses, and methods may be implemented in other ways. For example, the apparatus embodiments described above are merely illustrative, e.g., the partitioning of modules is merely a logical function partitioning, and other partitioning may be performed in actual implementation, e.g., multiple modules or components may be combined or integrated into another system, or some features may be omitted, or not performed. In another aspect, the couplings or direct couplings or communication connections shown or discussed with respect to each other may be indirect couplings or communication connections through some interface, apparatus, or module, which may be electrical, mechanical, or in other form.

The modules illustrated as separate components may or may not be physically separated, and the components shown as modules may or may not be physical modules, i.e., may be located in one place or may be distributed over a plurality of network elements. Some or all of the modules may be selected to achieve the objectives of the embodiments based on actual needs. For example, various functional modules in various embodiments of the present disclosure may be integrated into one processing module, or each module may physically exist separately, or two or more modules may be integrated into one module.

The above is only some specific embodiments of the present disclosure, but the protection scope of the present disclosure is not limited thereto. Changes or replacements may be made by the person skilled in the art within the technical scope disclosed in the present disclosure, and should be covered by the protection scope the present disclosure. Therefore, the protection scope of the present disclosure is defined by the claims as attached.

1. A text processing method, comprising:
obtaining a source text;
inputting the source text into a sequence-to-sequence model, to obtain a target sequence corresponding to the source text; and
converting the target sequence into a target table.

2. The method of claim 1, wherein:
the sequence-to-sequence model is an encoder and decoder framework;
the decoder is of an N-layer structure and comprises an output embedding layer, an N-layer self-attention network, an N-layer first processing network, and a second processing network, the self-attention network adopting a single-head self-attention mechanism or a multi-head self-attention mechanism; and
the inputting the source text into the sequence-to-sequence model, to obtain the target sequence corresponding to the source text comprises:
S1: obtaining and processing, by the encoder, the source text, to obtain a hidden state of the source text;
S2: obtaining and processing, by the output embedding layer for any to-be-outputted word in the target sequence, at least one outputted word in the target sequence, to obtain at least one word vector corresponding to the at least one outputted word;
S3: obtaining, by a first layer self-attention network in the N-layer self-attention network, the at least one word vector for each head in the single-head self-attention mechanism or multi-head self-attention mechanism, determining a header relationship vector between a first word vector and each second word vector, and obtaining a third word vector based on the header relationship vector between the first word vector and each second word vector, and the at least one word vector, the first word vector being a last word vector in the at least one word vector, the second word vector being any word vector in the at least one word vector, and the third word vector corresponding to the first word vector;
S4: processing, by a first layer first processing network in the N-layer first processing network, the third word vector based on the hidden state, to obtain a fourth word vector;
S5: performing S3, by a second layer self-attention network in the N-layer self-attention network taking the fourth word vector as a new first word vector and taking a word vector obtained by processing each second word vector by the first layer first processing network as each new second word vector, until an N^{th} layer first processing network in the N-layer first processing network outputs a fifth word vector corresponding to the first word vector; and
S6: processing, by the second processing network, the fifth word vector, to obtain the to-be-outputted word.

3. The method of claim 2, wherein the determining, by the first layer self-attention network, the header relationship vector between the first word vector and the second word vector comprises:
determining, by the first layer self-attention network, whether the first word vector and the second word vector have a header relationship;
when the first word vector and the second word vector have no header relationship, determining, by the first layer self-attention network, the header relationship vector between the first word vector and the second word vector as a zero vector;
when the first word vector and the second word vector have a row header relationship, determining, by the first layer self-attention network, the header relationship vector between the first word vector and the second word vector as a first vector; and
when the first word vector and the second word vector have a column header relationship, determining, by the first layer self-attention network, the header relationship vector between the first word vector and the second word vector as a second vector.

4. The method of claim 2, wherein the obtaining the third word vector by the first layer self-attention network based on the header relationship vector between the first word vector and each second word vector, and the at least one word vector comprises:
performing, by the first layer self-attention network, a first transformation on the first word vector, to obtain a query corresponding to the first word vector;
performing, by the first layer self-attention network, a second transformation on the each second word vector, to obtain a key corresponding to each second word vector;
determining, by the first layer self-attention network, a similarity between the first word vector and each second word vector based on the query corresponding to the first word vector, the key corresponding to each second word vector, and a first header relationship vector between the first word vector and each second word vector, wherein the header relationship vector between the first word vector and each second word vector comprises: the first header relationship vector being a header relationship vector corresponding to the key corresponding to each second word vector;
performing, by the first layer self-attention network, a third transformation on each second word vector, to obtain a value corresponding to each second word vector; and
determining, by the first layer self-attention network, the third word vector based on the similarity between the first word vector and each second word vector, the value corresponding to each second word vector, and a second header relationship vector between the first word vector and each second word vector, wherein the header relationship vector between the first word vector and each second word vector comprises: the second header relationship vector being a header relationship vector corresponding to the value corresponding to each second word vector.

5. The method of claim 4, wherein the determining, by the first layer self-attention network, the similarity between the first word vector and each second word vector based on the query corresponding to the first word vector, the key corresponding to each second word vector, and the first header relationship vector between the first word vector and each second word vector comprises:
calculating, by the first layer self-attention network, a sum of the key corresponding to each second word vector and the first header relationship vector between the first word vector and each second word vector, to obtain a first result;
calculating, by the first layer self-attention network, a product of the query corresponding to the first word vector and the first result, to obtain a second result;
calculating, by the first layer self-attention network, a quotient of the second result and a dimension of the query corresponding to the first word vector, to obtain a third result; and
performing, by the first layer self-attention network, normalization processing on each third result, to obtain the similarity between the first word vector and each second word vector.

6. The method of claim 4, wherein the determining, by the first layer self-attention network, the third word vector based on the similarity between the first word vector and each second word vector, the value corresponding to each second word vector, and the second header relationship vector between the first word vector and each second word vector comprises:
calculating, by the first layer self-attention network, a sum of the value corresponding to each second word vector and the second header relationship vector between the first word vector and each second word vector, to obtain a fourth result;
multiplying, by the first layer self-attention network, each fourth result with a corresponding similarity, to obtain a fifth result; and
calculating, by the first layer self-attention network, a sum of all the fifth results, to obtain the third word vector.

7. The method of claim 2, wherein a process of decoding the source text by the decoder satisfies the following decoding constraints:
when generating a first row of the target sequence, only a line break or an end mark is generated after a delimiter; and
when generating remaining rows of the target sequence other than the first row, the number of columns of the remaining rows is same as the number of columns of the first row, and only a line break or an end mark is generated after a delimiter.

8. A model training method, comprising:
obtaining a plurality of first training samples and an initial model, the first training sample comprising: a text and a table corresponding to the text;
converting the table into a sequence, the text and the sequence constituting a second training sample; and
training the initial model with a plurality of second training samples corresponding to the plurality of first training samples to obtain a sequence-to-sequence model.

9. The method of claim 8, wherein the converting the table into the sequence comprises:
separating different cells of the same row in the table with delimiters and separating different rows in the table with line breaks to obtain the sequence.

10. (canceled)

11. (canceled)

12. (canceled)

13. (canceled)

14. An electronic device, comprising:
a processor; and
a memory having a computer program stored thereon, wherein the processor is configured to invoke and execute the computer program stored in the memory to:
obtain a source text;
input the source text into a sequence-to-sequence model, to obtain a target sequence corresponding to the source text; and
convert the target sequence into a target table.

15. The electronic device of claim 14, the sequence-to-sequence model is an encoder and decoder framework;
the decoder is of an N-layer structure and comprises an output embedding layer, an N-layer self-attention network, an N-layer first processing network, and a second processing network, the self-attention network adopting a single-head self-attention mechanism or a multi-head self-attention mechanism; and
the inputting the source text into the sequence-to-sequence model, to obtain the target sequence corresponding to the source text comprises:
S1: obtaining and processing, by the encoder, the source text, to obtain a hidden state of the source text;
S2: obtaining and processing, by the output embedding layer for any to-be-outputted word in the target sequence, at least one outputted word in the target sequence, to obtain at least one word vector corresponding to the at least one outputted word;
S3: obtaining, by a first layer self-attention network in the N-layer self-attention network, the at least one word vector for each head in the single-head self-attention mechanism or multi-head self-attention mechanism, determining a header relationship vector between a first word vector and each second word vector, and obtaining a third word vector based on the header relationship vector between the first word vector and each second word vector, and the at least one word vector, the first word vector being a last word vector in the at least one word vector, the second word vector being any word vector in the at least one word vector, and the third word vector corresponding to the first word vector;
S4: processing, by a first layer first processing network in the N-layer first processing network, the third word vector based on the hidden state, to obtain a fourth word vector;
S5: performing S3, by a second layer self-attention network in the N-layer self-attention network taking the fourth word vector as a new first word vector and taking a word vector obtained by processing each second word vector by the first layer first processing network as each new second word vector, until an N^{th} layer first processing network in the N-layer first processing network outputs a fifth word vector corresponding to the first word vector; and
S6: processing, by the second processing network, the fifth word vector, to obtain the to-be-outputted word.

16. The electronic device of claim 15, wherein the determining, by the first layer self-attention network, the header relationship vector between the first word vector and the second word vector comprises:
determining, by the first layer self-attention network, whether the first word vector and the second word vector have a header relationship;
when the first word vector and the second word vector have no header relationship, determining, by the first layer self-attention network, the header relationship vector between the first word vector and the second word vector as a zero vector;
when the first word vector and the second word vector have a row header relationship, determining, by the first layer self-attention network, the header relationship vector between the first word vector and the second word vector as a first vector; and
when the first word vector and the second word vector have a column header relationship, determining, by the first layer self-attention network, the header relationship vector between the first word vector and the second word vector as a second vector.

17. The electronic device of claim 15, wherein the obtaining the third word vector by the first layer self-attention network based on the header relationship vector between the first word vector and each second word vector, and the at least one word vector comprises:
performing, by the first layer self-attention network, a first transformation on the first word vector, to obtain a query corresponding to the first word vector;
performing, by the first layer self-attention network, a second transformation on the each second word vector, to obtain a key corresponding to each second word vector;
determining, by the first layer self-attention network, a similarity between the first word vector and each second word vector based on the query corresponding to the first word vector, the key corresponding to each second word vector, and a first header relationship vector between the first word vector and each second word vector, wherein the header relationship vector between the first word vector and each second word vector comprises: the first header relationship vector being a header relationship vector corresponding to the key corresponding to each second word vector;
performing, by the first layer self-attention network, a third transformation on each second word vector, to obtain a value corresponding to each second word vector; and
determining, by the first layer self-attention network, the third word vector based on the similarity between the first word vector and each second word vector, the value corresponding to each second word vector, and a second header relationship vector between the first word vector and each second word vector, wherein the header relationship vector between the first word vector and each second word vector comprises: the second header relationship vector being a header relationship vector corresponding to the value corresponding to each second word vector.

18. The electronic device of claim 17, wherein the determining, by the first layer self-attention network, the similarity between the first word vector and each second word vector based on the query corresponding to the first word vector, the key corresponding to each second word vector, and the first header relationship vector between the first word vector and each second word vector comprises:
calculating, by the first layer self-attention network, a sum of the key corresponding to each second word vector and the first header relationship vector between the first word vector and each second word vector, to obtain a first result;
calculating, by the first layer self-attention network, a product of the query corresponding to the first word vector and the first result, to obtain a second result;
calculating, by the first layer self-attention network, a quotient of the second result and a dimension of the query corresponding to the first word vector, to obtain a third result; and
performing, by the first layer self-attention network, normalization processing on each third result, to obtain the similarity between the first word vector and each second word vector.

19. The electronic device of claim 17, wherein the determining, by the first layer self-attention network, the third word vector based on the similarity between the first word vector and each second word vector, the value corresponding to each second word vector, and the second header relationship vector between the first word vector and each second word vector comprises:
calculating, by the first layer self-attention network, a sum of the value corresponding to each second word vector and the second header relationship vector between the first word vector and each second word vector, to obtain a fourth result;
multiplying, by the first layer self-attention network, each fourth result with a corresponding similarity, to obtain a fifth result; and
calculating, by the first layer self-attention network, a sum of all the fifth results, to obtain the third word vector.

20. The electronic device of claim 15, wherein a process of decoding the source text by the decoder satisfies the following decoding constraints:
when generating a first row of the target sequence, only a line break or an end mark is generated after a delimiter; and
when generating remaining rows of the target sequence other than the first row, the number of columns of the remaining rows is same as the number of columns of the first row, and only a line break or an end mark is generated after a delimiter.

21. An electronic device, comprising:
a processor; and
a memory having a computer program stored thereon, wherein the processor is configured to invoke and execute the computer program stored in the memory to perform the method of claim 8.

22. The electronic device of claim 21, wherein the converting the table into the sequence comprises:
separating different cells of the same row in the table with delimiters and separating different rows in the table with line breaks to obtain the sequence.

23. A computer-readable storage medium, having a computer program stored thereon, wherein the computer program causes a computer to perform the method of claim 1.

24. A computer-readable storage medium, having a computer program stored thereon, wherein the computer program causes a computer to perform the method of claim 8.
